(19) United States
(12) Patent Application Publication
(10) Pub. No.: US 2010/0036691 A1
(43) Pub. Date: Feb. 11, 2010

(54) PHASE DRIVEN MODELING SERVICES

(75) Inventors: RICHARD BRADLEY BOULDIN, LEANDER, TX (US); TAL FRIEDMAN, THORNHILL (CA); MICHAEL DOUGLAS JAMES SHIELDS, TORONTO (CA); WENHUI WANG, MARKHAM (CA); KIRK WENDLAND, TORONTO (CA)

Correspondence Address: IBM - SPP;SHIMOKAJI & ASSOCIATES, P.C., 8911 Research Drive, Irvine, CA, 92618, US

(73) Assignee: INTERNATIONAL BUSINESS MACHINES CORPORATION, Armonk, NY (US)

(21) Appl. No.: 12/187,306

(22) Filed: Aug. 6, 2008

(51) Int. Cl. G06Q 10/00

(52) U.S. Cl. 705/7

(57) ABSTRACT

A software project management method uses templates from one project phase as inputs to their subsequent project phases. The project is organized in four phases, each phase having one or more steps and one or more attributes. Using XSL, a phase model is transformed into a starting point as input for the subsequent phase model. XSL-FO is used to generate PDF documents from any phase model to export a particular project deliverable. The information and data created within that phase still has meaning as input for the next phase. A model thus derived can be reused for another project as well as to transform into a model used by a subsequent phase within the same project.

### BACKGROUND OF THE INVENTION

The invention relates generally to the field of software tools for project management.

The traditional method to handle reuse amongst projects is to share templates. Each phase within a project will input relevant information into these templates which are then used as project deliverables. Examples of deliverables are the inputs and outputs of documents, demonstrations, proof of concepts and implementation assets. The limitation with this current exchange of templates is that they are generic and do not contain specific information that pertain to a particular project.

Hence, there is a need for an improved method and system of managing projects.

### SUMMARY OF THE INVENTION

In one aspect, the invention provides a method of organizing a project as a plurality of phases, each phase having one or more attributes and one or more steps, the method comprising organizing the plurality of phases in an ordered sequence, communicating information from a previous phase of the ordered sequence to a next phase of the ordered sequence by generating one or more XML templates and appending phase specific information to each of said one or more XML templates, producing at least one template for a next phase by extracting information from a template received from a previous phase; wherein each phase comprises an artifact step for delivering an output file using one of XSL and XSL-FO format, a pattern step for inspecting a model for information that can be transformed into an artifact and a model attribute that captures data related to each phase in an XML format and wherein the project comprises a solution outline phase for converting user and business requirement into one or more high level use cases, a macro design phase for developing architectural information and scope of technologies, a micro design phase for producing user experience information and a list of artifacts produced by the project, and a build phase for developing and testing an application.

These and other features, aspects and advantages of the present invention will become better understood with reference to the following drawings, description and claims.

### BRIEF DESCRIPTION OF THE DRAWINGS

FIG. 1 is a flow chart showing an exemplary method of executing a project in accordance with an embodiment of the present invention;

FIG. 2 is a block diagram showing schematic exemplary phases and deliverables of a project executed in accordance with an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The following abbreviations are used in this description: Portable Document Format (PDF), eXtensible Markup Language (XML), eXtensible Stylesheet Library (XSL), Formatted Object (FO) and Phase Driven Modeling Services (PDMS).

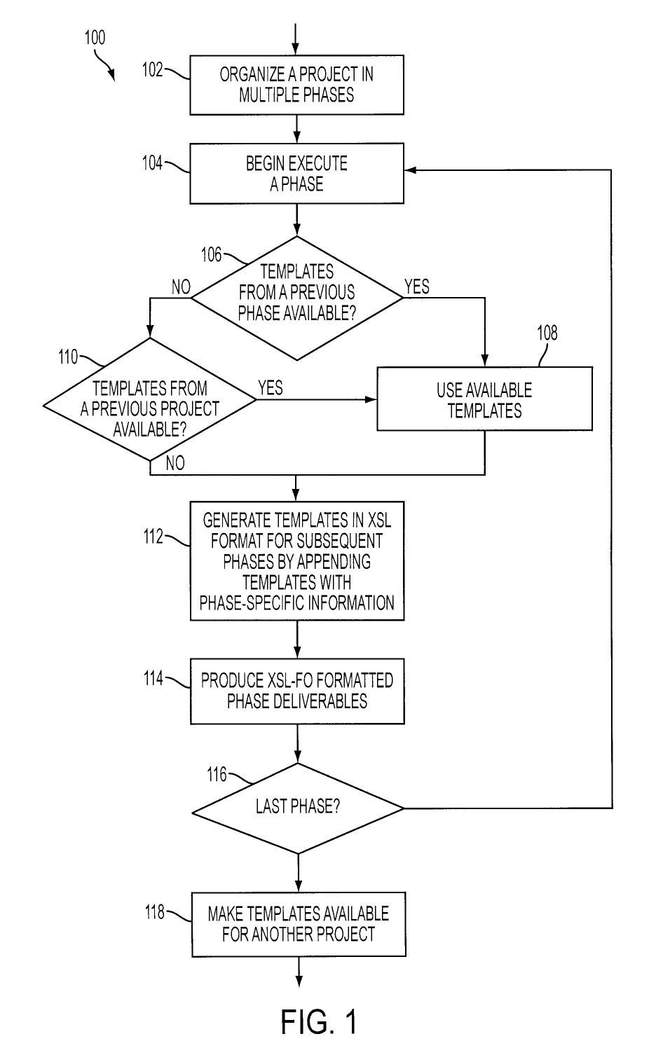

FIG. 1 shows a flowchart 100 of steps of an exemplary method of executing a project in accordance with an embodiment of the present invention. These steps may be executed on a computer or another hardware device, (not shown in the diagram). The computer may have, for example, a central processor, a signal bus, memory circuitry and a hardware device for reading media such as a compact disc of a digital versatile disk. In step 102, a user, who may be a project stakeholder, or the computer, may organize a project in multiple phases of execution. The project stakeholder may initiate execution of a phase of the project in step 104.

While the steps below are described using the computer as the actor performing these steps, in various embodiments, a project stakeholder or a computer may implement some or all of these steps.

The computer may check in step 106 if one or more templates from a previous phase are available. If these templates are available, then the computer may use the available templates (step 108). Otherwise, the computer may check in step 110 if templates from previous projects are available, and if available, the computer may use these templates in step 108. In step 112, the computer may generate templates for the phase being executed by appending an already available template with information specific to the phase being executed, or by creating a new template, if no previous template is available. The computer may advantageously generate this template in the XSL format. The XSL format allows a semantically structured representation of the information. In step 112, the computer may produce any deliverables of the phase being executed. In one embodiment, the computer may produce these deliverables as XSL-FO formatted documents. If the phase being executed is the last phase (decision box 114), then the computer may make the templates generated for the project available to future projects (step 118). Otherwise, the computer may proceed to execute a next phase of the project in step 104.

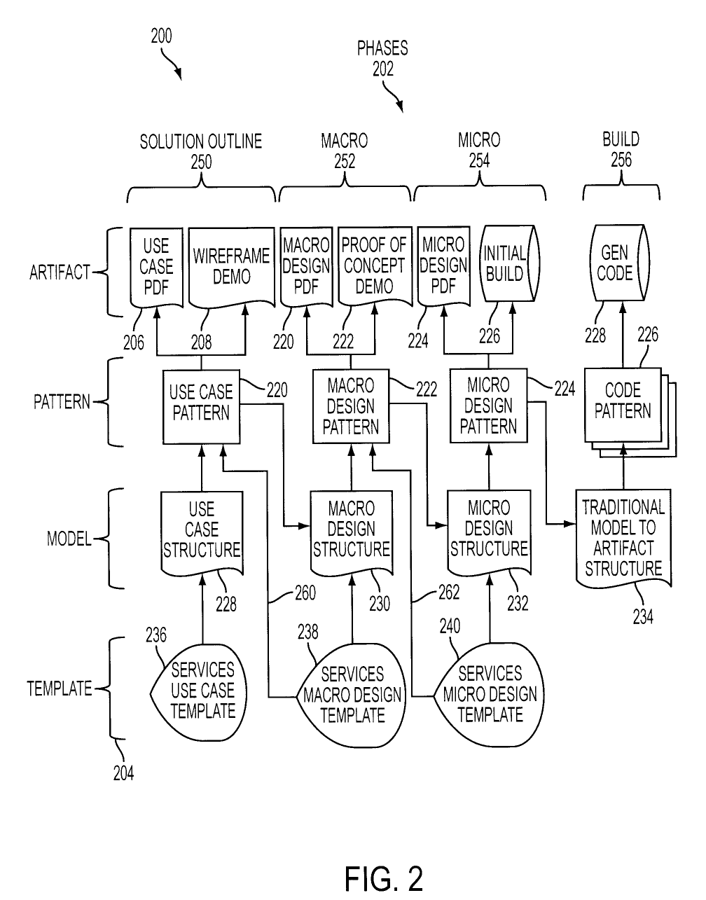

FIG. 2 shows an example workflow 200 of a project 100 organized according to an embodiment of the present invention. The workflow 200 may be organized for execution generally along the method described in FIG. 1. To achieve this, the workflow 200 may be organized as four phases 202: a Solution Outline phase 250, a Macro phase 252, a Micro phase 254, and a Build phase 256. This workflow 200 shows how a project stakeholder (not shown in the figure) may organize a project in phases and define inputs and outputs for each phase. Each phase in turn may have a number of attributes 204, such as an artifact, a pattern, a model and a template.

In the exemplary embodiment shown in FIG. 2, the Solution Outline Phase 250 (further described below) may represent work performed to understand the user and the business requirements driving the effort and scope for the project. The project stakeholder may set output of this phase to be high level use cases written in a human comprehensible language. There may be a reusable asset which enables the creation of these high level use cases in document format 236 to which requires direct input.

The Macro Design phase 252 (further described below), may represent development of high-level information and technical architecture/design, and user experience design. The project stakeholder may set output of this phase to produce a set of more detailed use cases and details user experience information. The project stakeholder may also include architecture and design of the project in this document to help communicate high-level information of the plan and scope of the technologies used.

The project stakeholder may obtain detailed information architecture and experience design in the Micro Design phase 254 (further described below). The output of this phase 254 may produce detailed user experience information as well as may explicitly state all the artifacts that will produced in the project.

The project stakeholder may set the Build Phase 256 to develop and test the application. Typically, this phase may have processes in place to allow for model drive development, including a traditional model to artifact structure 234 and code patterns 226 producing generated code 228.

The project stakeholder may execute the project so that some of these phases may be implemented iteratively by benefitting from the work performed and results found in another phase. The present invention contemplates the use of documents in standardized XML formats for communication between phases. The decision of whether to iteratively perform a phase or not, and how many times to iterate a given phase, may be taken by a project stakeholder based on experience gathered during execution of the project or other similar projects, or by defining a metric (e.g., peer review) that may have to be met before a phase is considered completed. Further details of the inputs, outputs and tasks performed during each of these four phases are provided below.

More specifically, the Solution Outline phase 250 may use a template file 236 as its input. The template 236 may be an XML file with semantics situated to allow for transformations into a PDF document, a simple demonstration wireframe 208 as well as input towards the Macro Design phase 252. As shown in Table 1 and Table 2, the use case template can be represented in the XML format, which is typically different from a word processing file format used by the project stakeholders. However, when leveraging the PDMS, the template 236 can be a model used to produce a document that may be used to communicate the Solution Outline to the project stakeholders.

With the template 236 represented semantically in the XML format, a model 228 can then be used to generate artifacts to be used as phase deliverables and input to subsequent phases. Table 2 shows an exemplary model representation of the above template. Each attribute and element of this use case is semantically agreed to represent the template. This XML model shown in Table 2 can then be reused as the model for future projects engaged in the Solution Outline phase 250, thus allowing reuse of the processes in place for services to engage with customers.

TABLE 1

| Use Case Element | Description |
|---|---|
| Use Case Number | ID to represent your use case |
| Application | What system or application does this pertain to |
| Use Case Name | The name of your use case |
| Use Case Description | Elaborating more on the name, in paragraph form. |
| Primary Actor | Who is the main actor that this use case represents |
| Precondition | What preconditions must be met before this use |
| | case can start |
| Trigger | What event triggers this use case |
| Basic Flow | The basic flow should be the events of the |
| | use case |
| Alternate Flows | The most significant alternatives and exceptions |

TABLE 2

```
<UseCase number=”1234” name=”example”>
<useCaseElement name=”Application”>
    <entry>...</entry>
</useCaseElement>
<useCaseElement name=”Description”>
    <entry>...</entry>
</useCaseElement>
<useCaseElement name=”Primary Actor”>
    <entry>...</entry>
</useCaseElement>
...
</UseCase>
```

The model 228 may be populated with project related information which can then be transformed into meaningful assets. The model 228 can then be used as an input to the pattern step 220 of the Solution Outline phase 250. The pattern step 220 may represent the task inspect the model for meaningful information that can be transformed into artifacts. The pattern 220 may be implemented using a technology such as the Design Pattern Toolkit™ by International Business Machines Corporation or could simply be an XML transformation script. The pattern 220 may contain within it representations of reusable information that compliments the generated artifacts. For example, when creating PDF documents, the pattern 220 may contain the information that will best represent how the XSL-FO formatted XML file will look before the XSL-FO transformer will create the PDF file. If the project stakeholder decides to iterate between the Solution Outline phase 250 and the Macro Design phase 252, e.g., to improve the use cases generated by phase 250, the pattern step 220 may use feedback from the design template 238 of Macro Design phase 252 (shown as arrow 260), Also, the pattern step 220 may provide input to the model 230 used for the next phase. This model 230 may need to have some structure already in it to best represent the template of the Macro Design phase 252. Therefore, the pattern 220 within the Solution Outline phase 250 will contain the information necessary to be able to produce the Macro Design phase model 230 which holds the template structure as well as the Solution Outline phase 250 data. The artifacts that are produced may be meaningful to the Solution Outline phase 250 delivery outputs. These can be PDF documents 206 that are produced using XSL-FO technology.

More specifically, the Macro Design template 238 may be an XML file with semantics situated to allow for transformations into a PDF document, some possible proof of concepts and as well as input towards the Micro Design phase 254. As described above, the Macro Design template 238 could be used to provide input to the pattern step 220 of the Solution Outline phase 250. One advantage of this iterative process is that service changes to the Macro Design template 238 could be communicated to the pattern 220 contained within the Solution Outline phase. For example, if XSL transformations were to be the tool used to produce the Macro Design phase model 230, the Solution Outline phase pattern step 220 would contain the template necessary to produce the Macro Design Phase model 230. The model 230 of the Macro Design phase 252 may be a result of the transformation of the assets created from the Solution Outline Phase 250. Further input of information may be set directly into the model 230 itself. The pattern step 222 of the Macro Design phase 252 may inspect the model for meaningful information that can be transformed into artifacts for phase 252. The pattern 222 may be implemented using a technology such as the Design Pattern Toolkit™ or could simply be an XML transformation script. The pattern step 222 may contain within it representations of reusable information that compliments the generated artifacts. For example, when creating PDF documents, the pattern 222 must contain the information that will best represent how the XSL-FO formatted XML file will look before the XSL-FO transformer will create the PDF file. Another example of this is the model 232 that is output for the Micro Design phase 254. The present invention enables model 232 to have some structure already in it to effectively represent the template of the Micro Design phase 254. Therefore, the pattern 222 within the Macro Design phase 252 may contain the information necessary to be able to produce the Micro Design phase model 232 which holds the template structure as well as the Macro Design phase data. The artifacts that are produced are meaningful to the Macro Design phase outputs 220. Another set of artifacts 222 that can be created are a subset of the template that can be reused for another project where information of the phase input is similar. Other files that can be produced by the pattern 224 which can be output XML documents using XSL-FO notation. XSL-FO technology can then parse this Macro Design Phase 252 output XSL-FO files and generate PDF documents 224.

More specifically, the Micro Design template 240 may be an XML file with semantics situated to allow for transformations into a PDF document, as well as potentially producing artifacts that would be required by the project and user experience information. Because the present invention contemplates an iterative method, the Micro Design template 240 could have defined at least a part of the pattern of the Macro Design phase 252 via a feedback path 262. The pattern 222 may also include additional information. For example, if XSL transformations were to be the tool used to produce the Micro Design phase model 232, the Macro Design phase pattern 222 could contain the template necessary to produce the Micro Design phase model 232. The pattern 224 may carry over the template that is the starting point for augmenting the allocation of information for the Micro Design phase 254. Further input of information may be set directly into the model 232 itself. The pattern 224 may represent a step in which the model 232 is inspected for useful information that can be transformed into artifacts (e.g., a design PDF 224 and an initial build 228) and may be a technology such as the Design Pattern Toolkit™ or could simply be an XML transformation script. A project stakeholder may perform the communication between pattern step 222 and the model 232 iteratively, so as to improve the effectiveness of the project to meet the high level business objectives. The pattern 224 may contain within it representations of reusable information that compliments the generated artifacts. For example, when creating PDF documents, the pattern 224 must contain the information that will best represent how the XSL-FO formatted XML file will look before the XSL-FO transformer will create the PDF file. The artifacts micro design PDF 224 and initial build 226 that are produced may be meaningful to the Micro Design phase 254 outputs. Another set of artifacts that can be created are a subset of the template that can be reused for another project where information of the phase input is similar.

The exemplary method of execution of a project described above thus provides a mechanism for appending a phase specific information to templates that can be reused by subsequent phases (feed-forward information), or can be reused by a previous phase of a project (feedback information). This allows for an efficient transition from phase to phase within a project. This mechanism further advantageously allows a prior step in a phase of the project to provide input to a next step of the same phase by either providing direct input to the next step, or by providing feedback to a previous phase, which in turn provides an input to the next step of the phase. Furthermore, components of a particular phase template can be extracted and that transferred to another project. Easily transferable assets also allow for an efficient project to project transition.

It would be recognized by those skilled in the art, that the invention described herein can take the form of an entirely hardware embodiment, an entirely software embodiment, or an embodiment containing both hardware and software elements. In an exemplary embodiment, the invention may be implemented in software, which includes but is not limited to firmware, resident software, microcode, etc.

In this case, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

It should be understood, of course, that the foregoing relates to exemplary embodiments of the invention and that modifications may be made without departing from the spirit and scope of the invention as set forth in the following claims.

We claim:

1. A method of organizing a project as a plurality of phases, each phase having one or more attributes and one or more steps, the method comprising:
organizing the plurality of phases in an ordered sequence;
communicating feed-forward information from a previous phase of said ordered sequence to a next phase of said ordered sequence by
generating one or more XML templates; and
appending phase specific information to each of said one or more XML templates;
communicating feedback information from at least one phase of the plurality of phases to a previous phase, the feedback information comprising an XML template;
producing at least one XML template for each phase of the plurality of phases by extracting information from a template received from at least one other phase of the plurality of phases;
wherein each of the plurality of phases comprises:
a first step for delivering an output file using one of XSL and XSL-FO format,
a second step for inspecting a model for information that can be transformed into an artifact and a model attribute that captures data related to said each phase in an XML format; and
wherein said project comprises:
a solution outline phase for converting a plurality of user and business requirements into one or more use cases described in a human comprehensible language;
a macro design phase for developing architectural information and scope of technologies;
a micro design phase for producing user experience information and a plurality of artifacts required by said project; and
a build phase for developing and testing an application.
